(19) United States
(12) Patent Application Publication
(10) Pub. No.: US 2020/0077128 A1
(43) Pub. Date: Mar. 5, 2020

(54) DIGITAL STREAMING DATA SYSTEMS AND METHODS

(71) Applicant: Gideon Eden, Lexington, MA (US)

(72) Inventor: Gideon Eden, Lexington, MA (US)

(21) Appl. No.: 16/117,251

(22) Filed: Aug. 30, 2018

(51) Int. Cl. H04N 21/242; H04N 21/233; H04N 21/234; H04N 21/2187

(52) U.S. Cl. CPC H04N 21/242; H04N 21/2187; H04N 21/23406; H04N 21/233

(57) ABSTRACT

The disclosure includes a digital streaming data system for synchronizing digital data to a viewer. Methods of using the system may include streaming audio data to a first remote computing device, wherein the audio data comprises audio commentary about a live event. Methods may further include streaming video data to a second remote computing device, wherein the video data is depicted from the live event. Additionally, methods may include the data streaming system synchronizing the audio data on the first remote computing device with the video data presented on the second remote computing device, such that the audio data and the video data may be substantially simultaneously presented.

### BACKGROUND

### Field

Various embodiments disclosed herein relate to digital streaming data systems and methods.

### Description of Related Art

Traditional commercial television broadcasting provides viewers with content composed of both video streaming data and audio streaming data. Live events constitute a widely broadcasted portion of television programming, including news, political events, sporting events, parades, concerts, and the like. Live events are often accompanied by audio data along with the video data, such as direct audio recordings from the events, and commentary generated by television broadcasting personnel. As television communication grows internationally, viewers are able to watch live events that originate from all over the world. However, the accompanying audio may not always be desirable to the viewer, or meet the viewer's expectations. If a viewer wishes to view a news station or local event of a foreign country, translation may be necessary, but not always offered by the television broadcasting providers. While live events, such as a parade or concert, may be accompanied by audio commentary, a viewer may wish to hear the observations of a person participating in the festivities. As well, a viewer watching a sporting event may be more interested in commentary from a local fan community than the commentary provided by the broadcasting television station. Such fans may resort to listening to local radio stations while watching the event in order to obtain the information they desire. With this solution, as the audio data and the video data are transferred via various independent communication channels, there is usually an inherent delay between the streaming of the audio data and the video data. The operation of communication satellites and the digital processing mechanisms in servers, which may be different paths for the commentator and the viewer, often results in a non-synchronized video and audio data presentation. Thus, there is a need for a more effective way to synchronize audio data and video data received from different communication channels in order to provide alignment between the video streaming data and the audio streaming data.

### SUMMARY

The disclosure describes methods of using a digital streaming data system. The data streaming system may synchronize digital data to a viewer. Methods of using the streaming data system may include audio data streaming to a first remote computing device. The audio data may consist of audio commentary about a live event. Methods of using the digital streaming data system may further include streaming video data to a second remote computing device. The video data may consist of a depiction of a live event. As well, methods of using the digital streaming data system may include synchronizing, by the digital streaming data system, the audio data on the first remote computing device with the video data presented on the second remote computing device.

Methods of using the streaming data system may include determining whether one of the audio data and the video data arrives at the data streaming system first. In some embodiments, the audio data may arrive at the data streaming system first. Methods of using the system may comprise delaying the audio data until the audio data and the video data may be substantially simultaneously presented on the data streaming system. In some embodiments, the video data may arrive at the data streaming system first. Methods of using the system may comprise delaying the video data until the audio and video data can be substantially simultaneously presented on the data streaming system.

A first time data may be associated with the timing of the audio data, and a second time data may be associated with the timing of the video data. Methods of using the system may include performing at least one of determining whether the first time data is greater than the second time data, and determining whether the second time data is greater than the first time data.

In some embodiments, the first time data may be greater than the second time data. In response to the first time data being greater than the second time data, methods may include continuously storing, by the data streaming system, a portion of the audio data. The portion of the audio data may be substantially equal to a difference between the first time data and the second time data. The result of storing the portion of the audio data may be a delayed buffered audio data. Methods may further include presenting, by the data streaming system, the delayed buffered audio data and the video data substantially simultaneously.

In some embodiments, the second time data may be greater than the first time data. In response to the second time data being greater than the first time data, methods may include continuously storing, by the data streaming system, a portion of the video data. The portion of the video data may be substantially equal to a difference between the second time data and the first time data. The result of storing the portion of the video data may be a buffered delayed video. Methods may further include presenting, by the data streaming system the buffered delayed video and the audio data substantially simultaneously.

Methods of using the data streaming system may include synchronizing the audio data and video data. Synchronizing the audio data and the video data may be performed by electronic circuitry delaying the audio data received at the first remote computing device. The data streaming system may include a memory arranged and configured to allow the viewer the ability to delay the video data until the audio data and the video data are substantially synchronized. The data streaming system may also include a server. The streaming steps may occur through a website.

The data streaming system may include a third remote computing device and a fourth remote computing device. The first remote computing device may be communicatively coupled to the third remote computing device. The audio data may be sourced from a commentator. The third remote computing device and the fourth remote computing device may be associated with the commentator. The first remote computing device and the second remote computing device may be associated with the viewer, and may be remotely located with respect to the third remote computing device and the fourth remote computing device. The data streaming system may provide a bidirectional text communication between the first remote computing device and the third remote computing device, such that the commentator and the viewer may communicate.

Methods of using the data streaming system may include recording the audio data with the third remote computing device. The third remote computing device may be communicatively coupled to the first remote computing device, and may be remotely located with respect to the first remote computing device. The data streaming system may transmit the audio data from the third remote computing device to the first remote computing device via the Internet. Transmitting the audio data from the third remote computing device to the first remote computing device may be performed via a website.

The data streaming system may synchronize digital data to a viewer. Methods of using the data streaming system may include streaming audio data to a first remote computing device. The audio data may consist of audio commentary about a live event. Methods may further include synchronizing, by the data streaming system, the audio data on the first remote computing device with video data presented on a second remote computing device. The second remote computing device may not be communicatively coupled to the first remote computing device. Video data may be streamed to the second remote computing device. The video data may be depicted from the live event. The data streaming system may include a third remote computing device and a fourth remote computing device. The first remote computing device may be communicatively coupled to the third remote computing device.

Methods of using the data streaming system may include streaming the audio data to a fifth remote computing device that is communicatively coupled to the third remote computing device. Methods may also include synchronizing, by the data streaming system, the audio data on the fifth remote computing device. The video data may be presented on a sixth remote computing device. The sixth remote computing device may not be communicatively coupled to the fifth remote computing device. At least one of the second remote computing device, the fourth remote computing device, and the sixth remote computing device may be a commercial television tuner. The commercial television tuner may display the video data depicted from the live event.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments.

FIG. 1 illustrates a schematic of a method of using a data streaming system, according to some embodiments.

FIG. 2 illustrates a flowchart of a method of using a data streaming system, according to some embodiments.

FIG. 3 illustrates a schematic of a method of using a data streaming system, according to some embodiments.

FIG. 4 illustrates a schematic of a method of using a data streaming system, according to some embodiments.

FIG. 5 illustrates a schematic of a method of using a data streaming system, according to some embodiments.

FIG. 6 illustrates a flowchart of a method of using a data streaming system, according to some embodiments.

FIG. 7 illustrates a schematic of a method of using a data streaming system, according to some embodiments.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### REFERENCE NUMERALS

10—Data streaming system
12—Audio data
14—First remote computing device
16—Live event
18—Video data
20—Second remote computing device

### 22—Camera

30—First time data
32—Second time data

### 34—Memory

### 36—Server

40—Third remote computing device
42—Fourth remote computing device
44—Fifth remote computing device
46—Sixth remote computing device

As the medium of television continues to evolve and grow on an international basis, a large variety of programming in the form of broadcasting video data has become widely available. Most of this programming is accompanied by some form of audio data, though this audio data is oftentimes not the audio desired by the viewer. When viewers try to watch programming with audio that is not the audio data supplied by the television broadcasting provider, there are inherent delays in transferring the video and audio data via the various communication channels. As such, this disclosure provides systems and methods for synchronization means that will align video streaming data and audio streaming data provided by different communication channels.

Such systems may include streaming audio data consisting of audio commentary about a live event to a first remote computing device, and streaming video data depicting the live event to a second remote computing device. The system may synchronize the audio data on the first remote computing device with the video data on the second remote computing device. Methods of using the system may include determining whether one of the audio data and the video data arrives at the data streaming system first by associating a first time data with the audio data and associating a second time data with the video data. In response to this determination, the system may delay at least one of the audio data and the video data such that the audio data and the video data may be substantially simultaneously presented. Methods may further include a third remote device and a fourth remote computing device associated with the source of the audio data and remotely located relative to the first remote computing device and the second remote computing device. The first remote computing device and the third remote computing device may be communicatively coupled. The audio data may be provided through a website.

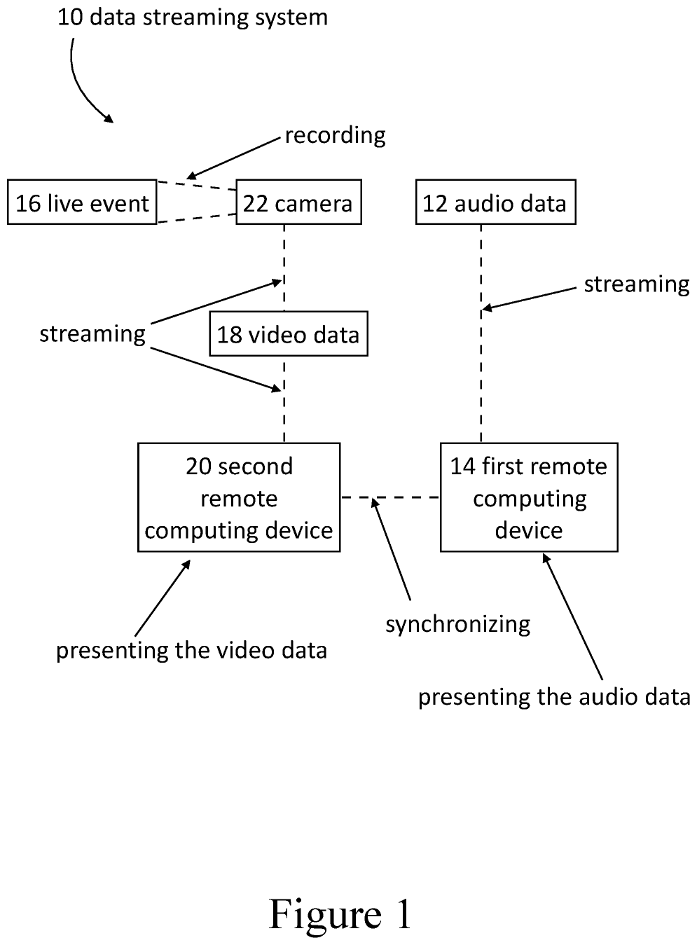

FIG. 1 illustrates a schematic of an embodiment of a method for using a data streaming system 10 (herein after referred to as “system 10”). The method for using the system 10 may include streaming audio data 12 to a first remote computing device 14. The first remote computing device 14 may include at least one of a smart phone, tablet device, laptop computer, desktop computer, smart watch, any device arranged and configured to communicate via a wired or wireless connection, and the like. The audio data 12 may consist of audio commentary about a live event 16. The audio data 12 may not be provided by the party that is providing the video data 18 by broadcasting the live event 16. The audio data 12 may be communicated by at least one of an internet based podcast site, direct internet communication, and the like.

The method may also include streaming video data 18 to a second remote computing device 20. The video data 18 may depict the live event 16. The second remote computing device 20 may include at least one of a smart phone, tablet device, desktop computer, laptop computer, television, smart television, any device arranged and configured to display the video data 18, and the like. The video data 18 may be recorded by a camera 22 and may depict the live event 16.

When streaming the audio data 12 and the video data 18 from different sources, there often exist inherent delays (could be tens of seconds) in the presentation of the audio data 12 and the video data 18. As such, the system 10 may be arranged and configured to synchronize the audio data 12 and the video data 18. Methods of using the system 10 may include synchronizing, by the system 10, the audio data 12 presented on the first remote computing device with the video data 18 presented on the second remote computing device 20.

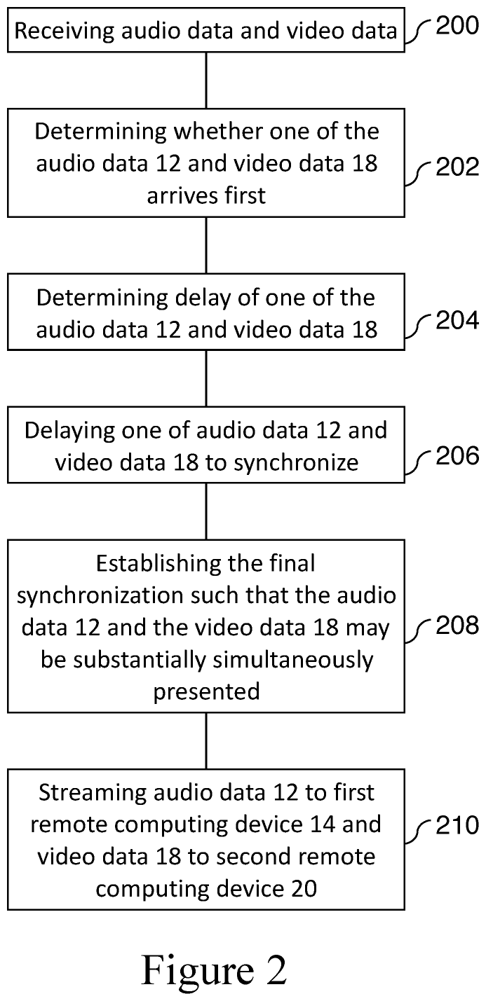

FIG. 2 illustrates a flowchart of an embodiment of a method for using the system 10. The system 10 may receive the audio data 12 and the video data 18 (at step 200). The system 10 may then determine whether one of the audio data 12 and the video data 18 arrives at the system 10 first (at step 202). In response to one of the audio data 12 and the video data 18 arriving at the system 10 first, the method may further include the system 10 determining the delay between the audio data 12 and video data 18 (at step 204).

In some embodiments, the audio data 12 may arrive at the system 10 first. Methods may then include the system 10 delaying the audio data 12 such that the audio data 12 may be synchronized with the video data 18 (at step 206). The audio data 12 may be delayed until the audio data 12 and the video data 18 may be synchronized and substantially simultaneously presented on the system 10 (at step 208). The synchronized audio data 12 may then be presented on the first remote computing device 14 and the synchronized video data 18 may be presented on the second remote computing device 20 (at step 210). It should be appreciated that the term “synchronized” means that the audio data 12 and the video data 18 are presented at substantially the same rate and time with respect to each other.

In some embodiments, the video data 18 may arrive at the system 10 first. Methods of using the system 10 may include the system 10 delaying the video data 18 such that the video data 18 may be synchronized with the audio data 12 (at step 206). The video data 18 may be delayed until the audio data 12 and the video data 18 may be synchronized and substantially simultaneously presented on the system 10 (at step 208). The synchronized audio data 12 may then be presented on the first remote computing device 14 and the synchronized video data 18 may be presented on the second remote computing device 20 (at step 210).

For example, a viewer may be streaming the video data 18 of a news broadcast originating in a foreign country (live event 16). The news broadcast may be provided in a language that the viewer does not speak nor understand. While foreign language news broadcasting channels often offer on screen text translation, words and phrases are often mistranslated and missed entirely by the translation typists. The viewer may employ the system 10 to stream audio data 12 that may consist of spoken language translation commentary originating from a commentator relating to the video data sent to a different location. The viewer may use the system 10 to ensure that the audio data 12, in the form of the spoken language translation commentary, may be presented substantially simultaneously with the video data 18, in the form of the news broadcast.

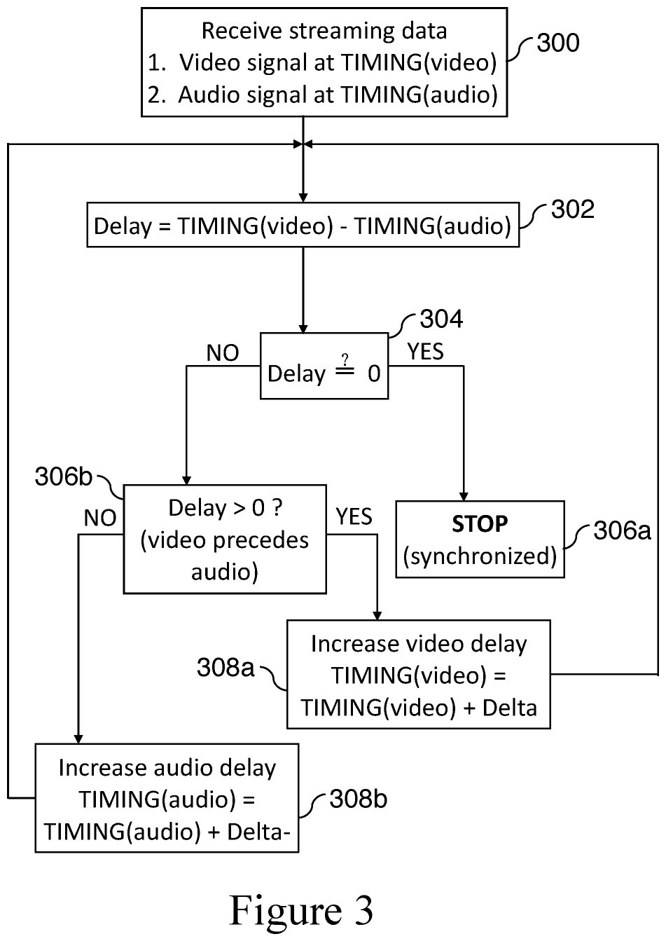

FIG. 3 illustrates a flowchart of a method for using the system 10. In some embodiments, a first time data 30 may be associated with the timing of the audio data 12 (referred to in FIG. 3 as “TIMING (audio)”). A second time data 32 may be associated with the timing of the video data 18 (referred to in FIG. 3 as “TIMING (video)”). The method may include the system 10 receiving the streaming data in the form of the audio data 12 and the video data 18 (at step 300). The method may further include performing at least one of determining whether the first time data 30 is greater than the second time data 32, and determining whether the second time data 32 is greater than the first time data 30. The system 10 may perform this determination by finding the difference in the timing of the audio data 12 and the timing of the video data 18 (at step 302). The system 10 may then determine the timing difference of the first time data 30 and the second time data 32 (at step 304). In some embodiments, the first time data 30 may be equal to the second time data 32, wherein the delay is equal to zero (at step 304). The system 10 may stop the incremental synchronization process since the audio data 12 and the video data 18 are synchronized (at step 306a).

In some embodiments, the system 10 may determine that a delay between the first time data 30 and the second time data 32 may exist (at step 304). The system 10 may then determine which of the first time data 30 and the second time data 32 arrives at the system 10 first. To determine this, the system 10 may then determine whether the delay is greater than or less than zero (at step 306b). A delay greater than zero may be defined as the second time data 32 of the video data 18 arriving at the system 10 before the first time data 30 of the audio data 12. When the delay is greater than zero, the system 10 may generate an incremental delay “Delta” by incremental video delay means. The system 10 may find the required increased video delay by adding the incremental delay “Delta” to the second time data 32 (at step 308a).

With added reference to FIG. 3, the system 10 may determine a delay less than zero (at step 306b). A delay less than zero may be defined as the first time data 30 of the audio data 12 arriving at the system 10 before the second time data 32 of the video data 18. When the delay is less than zero, the system may generate an incremental delay “Delta-” by incremental audio delay means. The system 10 may find the required increase audio delay by adding the incremental delay “Delta-” to the first time data 30 (at step 308b). It should be appreciated that the first time data 30 may be associated with the timing of the video data 18, and the second time data 32 may be associated with the timing of the audio data 12.

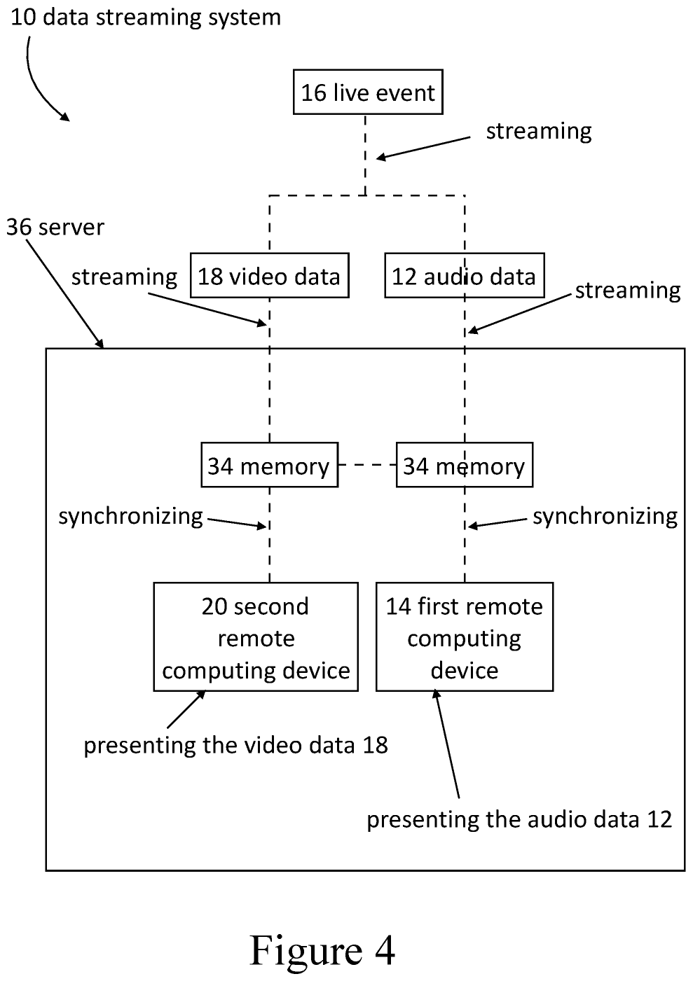

FIG. 4 illustrates a schematic of a method for using the system 10. In some embodiments, the first time data 30 may be greater than the second time data 32. In response to the first time data 30 being than the second time data 32 (audio data is ahead of the video data), the system 10 may generate the incremental audio delay means. The incremental audio delay means may be defined as continuously storing a portion of the audio data 12 on a memory 34. The memory 34 may store and buffer the audio data 12. The memory 34 may include at least one of a disk drive, random access memory (RAM), hard drive, external hard drive, solid-state drive, flash drive, secure digital card, and the like.

At least one of the system 10 and the viewer may store the audio data 12 on the memory 34. The portion of the audio data 12 that may be stored on the memory 34 may be substantially equal to a difference between the first time data 30 and the second time data 32. The system 10 may then synchronize the audio data 12 and the video data 18. The at least one of the system 10 and the viewer may then release the delayed buffered audio data 12 from the memory 34 to the first remote computing device 14 after the above difference delay time, such that the delayed buffered audio data 12 and the video data 18 may be presented substantially simultaneously. The delay time may be determined by at least one of the system 10 and the viewer. In some embodiments, the audio data 12 may be synchronized with the video data 18 by an electronic circuitry delaying the audio data 12 received at the first remote computing device 14.

With added reference to FIG. 4, the second time data 32 may be greater than the first time data 30. In response to the second time data 32 being greater than the first time data 30, the system 10 may generate the incremental video delay means. The incremental video delay means may be defined as continuously storing a portion of the video data 18 on the memory 34. The memory 34 may store and buffer the video data 18. The memory 34 may include at least one of a disk drive, random access memory (RAM), hard drive, external hard drive, solid-state drive, flash drive, secure digital card, and the like.

At least one of the system 10 and the viewer may store the video data 18 on the memory 34. The portion of the video data 18 that may be stored on the memory 34 may be substantially equal to a difference between the first time data 30 and the second time data 32. The system 10 may then synchronize the video data 18 and the audio data 12. The at least one of the system 10 and the viewer may release the delayed buffered video data 18 from the memory 34 to the second remote computing device 20 after a delay time, such that the delayed buffered video data 18 and the audio data 12 may be presented substantially simultaneously. The delay time may be determined by at least one of the system 10 and the viewer. In some embodiments, the video data 18 may be synchronized with the audio data 12 by the electronic circuitry delaying the video data 18 received at the second remote computing device 20.

In some embodiments, the system 10 may include a server 36. The server 36 may encompass a website. Methods of using the system 10 may include steps for streaming occurring through the website on the server 36. The server 36 may incorporate at least one of the memory 34 and the electronic circuitry that may delay at least one of the audio data 12 and the video data 18. The audio data 12 and the video data 18 may stream through the website of the server 36 to be synchronized by the system 10. The first remote computing device 14 may be connected to an internet such that the web site of the server 36 may be accessed. The first remote computing device 14 may be connected to the internet via at least one of an Ethernet cable, WiFi, dial-up, digital subscriber line (DSL), satellite, cellular technology, and the like.

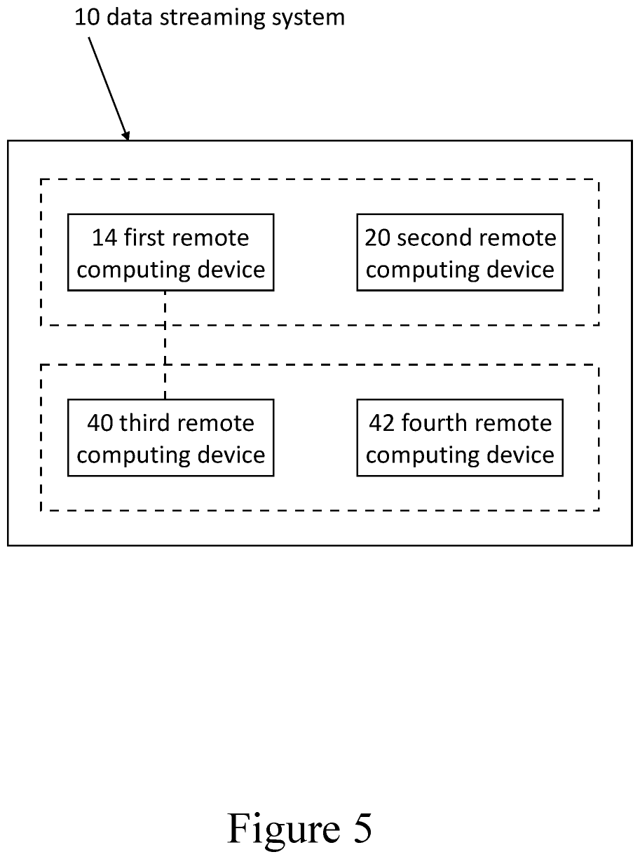

Referring now to FIG. 5, the system 10 may include a third remote computing device 40 and a fourth remote computing device 42. The first remote computing device 14 may be communicatively coupled to the third remote computing device 40. The third remote computing device 40 may stream the audio data 12 to the first remote computing device 14. The first remote computing device 14 may be communicatively coupled to the third remote computing device 40 via the server 36. The third remote computing device 40 may include at least one of a smart phone, tablet device, laptop computer, desktop computer, smart watch, any device arranged and configured to communicate via a wired or wireless connection. The third remote computing device 40 may also include a microphone such that the audio data 12 may be recorded. The fourth remote computing device 42 may include at least one of a smart phone, tablet device, desktop computer, laptop computer, television, smart television, any device arranged and configured to display the video data 18, and the like.

In some embodiments, the audio data 12 may be sourced from a commentator. The third remote computing device 40 and the fourth remote computing device 42 may be associated with the commentator. The first remote computing device 14 and the second remote computing device 20 may be associated with the viewer. The first remote computing device 14 and the second remote computing device 20 may be located remotely with respect to the third remote computing device 40 and the fourth remote computing device 42. The audio data 12 may be created by the commentator on the third remote computing device 40 and sent, via the server 36, to the first remote computing device 14. The viewer may stream the audio data 12 on the first remote computing device 14 via the website of the server 36. The user may register the time delay given the first time data 30 and the second time data 32 on the website such that the server 36 may synchronize the audio data 12 and the video data 18 in order to achieve substantial simultaneous streaming.

In some embodiments, the system 10 may incorporate providing a bidirectional text communication between the first remote computing device 14 and the third remote computing device 40. As such, the viewer and the commentator may communicate via the server 36. The bidirectional text communication may exist on the website. The viewer may be able to give the commentator feedback, ask questions, leave comments, answer questions, voice concerns, and the like. For example, a viewer watching a sporting event, such as a local college basketball game, may be utilizing the system 10 to watch the television broadcast of the sporting event and listen to a local fan community based commentator. The viewer may be able to request that the commentator discuss a new player on the team, ask the commentator why he made a particular comment, request that the commentator discuss a play in more detail, even challenge something the commentator said (e.g., a fact that the commentator said that the viewer does not believe to be true), and the like.

In some embodiments, the multidirectional text communication may encompass a plurality of viewers that are employing the system 10. The multidirectional text communication may allow for a forum of discussion among viewers and the commentator. As well, the commentator may utilize the multidirectional text communication to send a text communication to the plurality of viewers. Text communications sent via the multidirectional text communication may be sent and received in real time.

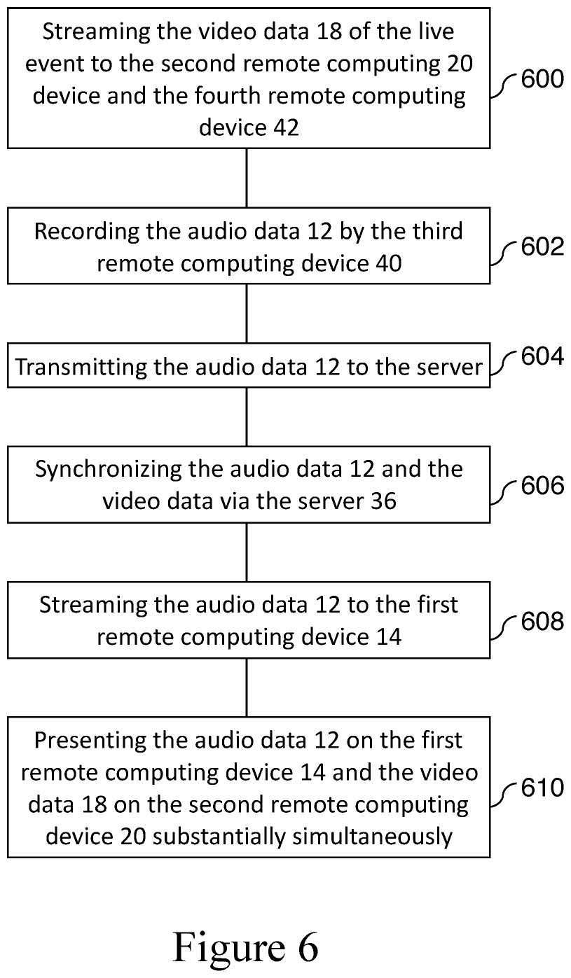

FIG. 6 illustrates a flowchart of a method for using the system 10. The method may include streaming the video data 18 to the second remote computing device 20 and the fourth remote computing device 42 (at step 600). The video data 18 may depict the live event 16. The commentator may record the audio data 12 on the third remote computing device 40 (at step 602). The third remote computing device 40 may be communicatively coupled to the first remote computing device 14, and may be remotely located with respect to the first remote computing device 14. The commentator may record the audio data 12 in real time as the live event 16 is being broadcasted. The fourth remote computing device 42 may broadcast the video data 18 of the live event 16, such that the commentator may be watching the live event 16 while recording the audio data 12 on the third remote computing device 40. The commentator may record the audio data 12 by means of at least one of a microphone, text to speech transcription, online voice recorder, and the like.

The method of using the system 10 may further consist of transmitting the audio data 12 from the third remote computing device 40 to the server 36 (at step 604). The audio data 12 may be transmitted to the server 36 via the Internet. The audio data 12 and the video data 18 may then be synchronized by the system 10 on the server 36 (at step 606). The audio data 12 and the video data 18 may be synchronized by means of delaying at least one of the audio data 12 and the video data 18, such that the audio data 12 and the video data 18 may be substantially simultaneously presented.

With added reference to FIG. 6, the method may include streaming the audio data 12 to the first remote computing device 14 (at step 608). The audio data 12 may be streamed to the first remote computing device 14 via the website of the server 36. The audio data 12 may consist of audio commentary about the live event 16. When the audio data 12 and the video data 18 are synchronized, the method may include presenting the audio data 12 on the first remote computing device 14, and the video data 18 on the second remote computing device 20 substantially simultaneously (at step 610). The second remote computing device 20 may not be communicatively coupled to the first remote computing device 14.

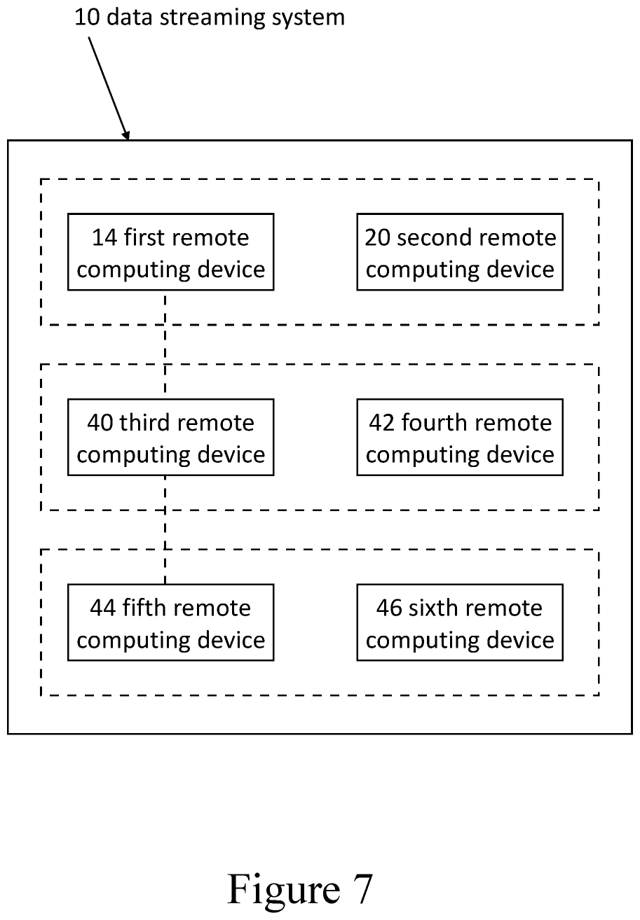

FIG. 7 illustrates a schematic of a method for using the system 10. The system 10 may include the third remote computing device 40 and the fourth remote computing device 42. The first remote computing device 14 may be communicatively coupled to the third remote computing device 40. The system 10 may also incorporate a fifth remote computing device 44 and a sixth remote computing device 46. The fifth remote computing device 44 may include at least one of a smart phone, tablet device, laptop computer, desktop computer, smart watch, any device arranged and configured to communicate via a wireless connection, and the like. The sixth remote computing device 46 may include at least one of a smart phone, tablet device, desktop computer, laptop computer, television, smart television, any device arranged and configured to display the video data 18, and the like.

In some embodiments, the audio data 12 may be streamed to the fifth remote computing device 44. The fifth remote computing device 44 may be communicatively coupled to the third remote computing device 40. The video data 18 depicting the live event 16 may be presented on the sixth remote computing device 46. The method of using the system 10 may include synchronizing, by the system 10, the audio data 12 streaming on the fifth remote computing device 44 with the video data 18 presented on the sixth remote computing device 46 such that the audio data 12 and the video data 18 may be presented substantially simultaneously. The sixth remote computing device 46 may not be communicatively coupled to the fifth remote computing device 44. The system 10 may synchronize the audio data 12 on the fifth remote computing device 44 and the video data 18 on the sixth remote computing device 46 by means exemplified in the schematic of FIG. 3.

In some embodiments, the fifth remote computing device 44 and the sixth remote computing device 46 may be remotely located with respect to the third remote computing device 40 and the fourth remote computing device 42. It should be appreciated that the third remote computing device 40 may stream the audio data 12 to an unlimited number of remote computing devices arranged and configured to communicate via a connection, such as a wireless connection, and stream the audio data 12. In some embodiments, at least one of the second remote computing device 20, the fourth remote computing device 42, and the sixth remote computing device 46 may consist of a commercial television tuner that may display the video data 18 depicting the live event 16.

### Interpretation

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments include A, B, and C. The term “and/or” is used to avoid unnecessary redundancy.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

1. A method of using a data streaming system to synchronize streaming video data from a live event with streaming audio data related to the live event, wherein the audio data and video data are unprocessed and provided to a viewer via independent communication channels having different inherent latencies and different providers, the method comprising:
presenting the audio data to the viewer by a first remote computing device within the data streaming system;
presenting the video data to the viewer by a second remote computing device within the data streaming system; and
synchronizing, by the viewer, the audio data on the first remote computing device with the video data presented on the second remote computing device.

2. The method of claim 1, further comprising determining, by at least one of the viewer and the data streaming system, whether one of the audio data and the video data arrives at the data streaming system first due to the different inherent latencies of the independent communication channels.

3. The method of claim 2, in response to the audio data arriving at the data streaming system first, the method further comprising delaying presenting the audio data on the first remote computing device, by at least one of the viewer and the data streaming system, until the audio data and the video data are can be substantially synchronized on the data streaming system.

4. The method of claim 2, in response to the video data arriving at the data streaming system first, the method further comprising delaying presenting the video data on the second remote computing device by at least one of the viewer and the data streaming system, until the audio data and the video data are substantially synchronized on the data streaming system.

5. The method of claim 1, wherein a first time data is associated with a timing of the audio data and a second time data is associated with the timing of the video data, the method further comprising performing at least one of:
determining, by at least one of the viewer and the data streaming system, whether the first time data is greater than the second time data; and
determining, by at least one of the viewer and the data streaming system, whether the second time data is greater than the first time data.

6. The method of claim 5, in response to the first time data being greater than the second time data, the method further comprising:
continuously storing, by at least one of the data streaming system and the first remote computing device, a portion of the audio data substantially equal to a difference between the first time data and the second time data thereby resulting in a delayed buffered audio data; and
presenting the delayed buffered audio data on the first remote computing device and the video data on the second remote computing device substantially simultaneously.

7. The method of claim 5, in response to the second time data being greater than the first time data, the method further comprising:
continuously storing, by at least one of the data streaming system and the second remote computing device, a portion of the video data substantially equal to a difference between the second time data and the first time data thereby resulting in a delayed buffered video data; and
presenting the delayed buffered video data on the second remote computing device and the audio data on the first remote computing device substantially simultaneously.

8. The method of claim 1, wherein synchronizing the audio data and the video data is performed by electronic circuitry delaying the audio data received at the first remote computing device.

9. The method of claim 1, wherein the data streaming system comprises memory arranged and configured to allow the viewer to delay the video data until the audio data and the video data are substantially synchronized.

10. The method of claim 1, wherein the data streaming system comprises a server and the presenting steps are performed through a website.

11. The method of claim 1, wherein the data streaming system comprises a third remote computing device and a fourth remote computing device, and wherein the first remote computing device is communicatively coupled to the third remote computing device.

12. The method of claim 11, wherein a source of the audio data is a commentator and the third remote computing device and the fourth remote computing device are associated with the commentator, wherein the first remote computing device and the second remote computing device are associated with the viewer and located remotely with respect to the third remote computing device and the fourth remote computing device.

13. The method of claim 12, the method further comprising providing bidirectional text communication data between the first remote computing device and the third remote computing device enabling the commentator and the viewer to communicate.

14. The method of claim 1, further comprising recording the audio data with a third remote computing device that is communicatively coupled to the first remote computing device and remotely located with respect to the first remote computing device.

15. The method of claim 14, further comprising transmitting the audio data from the third remote computing device to the first remote computing device via an Internet.

16. The method of claim 15 wherein transmitting the audio data from the third remote computing device to the first remote computing device is performed via a web site.

17. A method of streaming video data and audio data to viewers, wherein the video data and audio data are depicted from a live event, the audio data and the video data are unprocessed and provided to a viewer via independent communication channels having different inherent latencies and different providers, comprising:
streaming the video data via a commercial TV channel to a first remote computing device associated with a viewer, wherein the first remote computing device comprises a commercial TV monitor;
streaming a video signal via the commercial TV channel to a second remote computing device associated with a commentator wherein the second remote computing device comprises a commercial TV monitor located remotely with respect to the first remote computing device;
generating real time audio commentary data by the commentator and streaming the audio data via a third remote computing device, wherein the third remote computing device comprises a computer connected to an Internet;
streaming audio data, by a first remote computing device, wherein the first remote computing device comprises a computer connected to the Internet; and
delaying, by the viewer, at least one of the video data and the audio data until the video data and audio data are substantially synchronized.

18. The method of claim 17, further comprising streaming the video data to the second remote computing device.

19. (canceled)

20. (canceled)

21. The method of claim 17, further comprising providing bidirectional text communication between the first remote computing device and the third remote computing device whereby the commentator and viewer can communicate.

22. A method of using a data streaming system to synchronize digital data to a viewer, the method comprising:
streaming audio data to a first remote computing device, wherein the audio data comprises audio commentary about a live event;
streaming video data to a second remote computing device, wherein the video data is depicted from the live event;
synchronizing, by the data streaming system, the audio data on the first remote computing device with the video data presented on the second remote computing device;
wherein the data streaming system comprises a third remote computing device and a fourth remote computing device, and wherein the first remote computing device is communicatively coupled to the third remote computing device, and wherein a source of the audio data is a commentator and the third remote computing device and the fourth remote computing device are associated with the commentator, wherein the first remote computing device and the second remote computing device are associated with the viewer and located remotely with respect to the third remote computing device and the fourth remote computing device; and
providing bidirectional text communication between the first remote computing device and the third remote computing device whereby the commentator and viewer can communicate.
